(19) United States
(12) Patent Application Publication
(10) Pub. No.: US 2015/0150044 A1
(43) Pub. Date: May 28, 2015

(54) AUDIO/VIDEO-ON-DEMAND METHOD, SERVER, TERMINAL AND SYSTEM

(71) Applicant: Tencent Technology (Shenzhen) Company Limited, Shenzhen City (CN)

(72) Inventor: Ning JIANG, Shenzhen City (CN)

(21) Appl. No.: 14/609,153

(22) Filed: Jan. 29, 2015

Related U.S. Application Data
(63) Continuation of application No. PCT/CN2013/080647, filed on Aug. 1, 2013.

(30) Foreign Application Priority Data
Aug. 9, 2012 (CN) 201210282449.2

(51) Int. Cl. H04N 21/81; H04N 21/239; H04N 21/235; H04N 21/8549; H04N 21/234; H04N 21/437; H04N 21/435; H04N 21/4788; H04N 21/2665; H04N 21/233

(52) U.S. Cl. CPC H04N 21/8133; H04N 21/2665; H04N 21/2393; H04N 21/235; H04N 21/233; H04N 21/23424; H04N 21/437; H04N 21/435; H04N 21/4788; H04N 21/8549
USPC 725/32

(57) ABSTRACT

The disclosure belongs to the field of communication, and provides an audio/video-on-demand method, server, terminal and system. The method includes: receiving, from a first terminal, a request for the audio or video and an identification for an object associated with a second terminal; receiving blessing information from the first terminal, wherein the blessing information is audio information or video information; and sending the blessing information and the audio or video to the second terminal for playing. The disclosure can solve the problems that it is inconvenient for a user to input literal information to the first terminal character by character and the literal on-demand blessing information may lead to inaccurate expression of the user's real emotion and achieve the advantage of entering the on-demand blessing information conveniently and accurate expression of the user's real emotion since the user can enter an audio/video information as the on-demand blessing information.

### CROSS REFERENCE TO RELATED APPLICATIONS

This application is a continuation application under 35 U.S.C. §111(a) claiming priority under 35 U.S.C. §120 and 365(c) to International Application No. PCT/CN2013/080647, filed on Aug. 1, 2013, which claims the priority benefit of Chinese Patent Application No. Chinese Patent Application No. 201210282449.2, filed on Aug. 9, 2012, both of which are hereby incorporated by reference in their entireties.

### FIELD OF THE INVENTION

The disclosure relates to the field of communication, and particularly, to an audio/video-on-demand method, server, terminal and system.

### BACKGROUND

Audio-on-demand is one of the common functions of audio player software such as QQ Music and Sogou Music. People may request songs for others to deliver their wishes by the audio-on-demand software.

The existing audio-on-demand method comprises: firstly, the server receives an audio-on-demand request and corresponding on-demand object sent from a first terminal; take audio such as a song for example, when a user “XIAO MING” wants to request a song named “GONG XI FA CAI” for his friend “XIAO LIANG” to deliver New Year wishes in the Spring Festival, “XIAO MING” sends an on-demand request for the song named “GONG XI FA CAI” and an on-demand object to the server via the first terminal used by “XIAO MING”, wherein, the on-demand object is “XIAO LIANG” using the terminal. Secondly, the server receives literal on-demand blessing information sent from the first terminal; for example, when requesting the song named “GONG XI FA CAI”, “XIAO MING” input characters such as “Happy New Year!” to express his sincere wishes; the server receives the characters such as “Happy New Year!” sent by the first terminal. Thirdly, the server sends the audio with the blessing information to the second terminal for playing; for example, the server sends the song named “GONG XI FA CAI” and the “Happy New Year!” to the second terminal used by “XIAO LIANG”; after “XIAO LIANG” selects to play the song and the on-demand blessing information, the second terminal will display the “Happy New Year!” and play the song named “GONG XI FA CAI”.

The inventor finds that the above method has at least the following problems:

(1) A user needs to input the blessing information character by character. When there is large blessing information, the user will take much time to input the information. However, for those elderly users, it is a challenge to input many characters.

(2) For a same sentence, different readers will have different understanding, so the literal on-demand blessing information cannot accurately express the user's real emotion.

### SUMMARY OF THE INVENTION

In order to solve the problems that it is inconvenient for a user to input literal information and inaccurate expression of the user's real emotion caused by the literal on-demand blessing information used in the existing audio-on-demand method, the embodiment provides an audio/video-on-demand method, server, terminal and system. The technical solutions are as follows:

At an aspect, a method for providing audio or video on demand is provided, comprising:

receiving, from a first terminal, a request for the audio or video and an identification for an object associated with a second terminal;

receiving blessing information from the first terminal, wherein the blessing information is audio information or video information; and

sending the blessing information and the audio or video to the second terminal for playing.

At another aspect, an audio and video on demand server is provided, comprising:

a request receiving module, configured to receive, from a first terminal, a request for the audio or video and an identification for an object associated with a second terminal;

a blessing information receiving module, configured to receive blessing information from the first terminal, wherein the blessing information is audio information or video information; and

an information sending module, configured to send the blessing information and the audio or video to the second terminal for playing.

At another aspect, a terminal is provided, comprising:

a request sending module, configured to send a request for audio or video on demand and an identification for an object associated with a second terminal to a server; and

a blessing information sending module, configured to send blessing information to the server, wherein the blessing information is audio information or video information.

At another aspect, a terminal is provided, comprising:

information receiving module, configured to receive blessing information, audio/video and a corresponding playing mode sent from the server, wherein, the playing mode specifies playing the blessing information first and then playing the audio or video, or starting the audio or video with a fade-in mode after ending the blessing information with a fade-out mode; and

playing module, configured to play the blessing information and the audio/video according to the playing mode.

An audio/video-on-demand system is provided comprising the above server and the above terminal.

The following advantages may be achieved by the technical solutions provided by the embodiments of the disclosure: the problems that it is inconvenient for a user to input literal information to the first terminal character by character and the literal on-demand blessing information may lead to inaccurate expression of the user's real emotion may be solved and the advantage of entering the on-demand blessing information conveniently and accurate expression of the user's real emotion may be achieved since the user can enter an audio/video information as the on-demand blessing information.

### DESCRIPTION OF THE DRAWINGS

In order to explain the technical solutions of the embodiments more apparently, the accompanying drawings used in the embodiments will be introduced briefly hereinafter. Obviously, the following accompanying drawings described are merely some embodiments, and other accompanying drawings will be derived from these accompanying drawings by those skilled in the art without inventive work.

FIG. 1 is a structure schematic diagram showing an implementing environment related to the embodiments of the disclosure;

FIG. 2 is a flow diagram showing an audio/video-on-demand method according to one embodiment of the disclosure;

FIG. 3 is a flow diagram showing an audio/video-on-demand method according to one embodiment of the disclosure;

FIG. 4 is a flow diagram showing an audio/video-on-demand method according to one embodiment of the disclosure;

FIG. 5 is a structure block diagram showing an audio/video-on-demand server according to one embodiment of the disclosure;

FIG. 6 is a structure block diagram showing an audio/video-on-demand server according to one embodiment of the disclosure;

FIG. 7 is a structure block diagram showing an audio/video-on-demand server according to one embodiment of the disclosure;

FIG. 8 is a structure block diagram showing an audio/video-on-demand server according to one embodiment of the disclosure;

FIG. 9 is a structure block diagram showing a terminal according to one embodiment of the disclosure;

FIG. 10 is a structure block diagram showing a terminal according to one embodiment of the disclosure;

FIG. 11 is a structure block diagram showing a terminal according to one embodiment of the disclosure;

FIG. 12 is a structure block diagram showing an audio/video-on-demand system according to one embodiment of the disclosure.

### DETAILED DESCRIPTION

In order to make the technical solutions and advantages of the disclosure more apparent, the embodiments of the disclosure will be further illustrated in details in connection with accompanying figures.

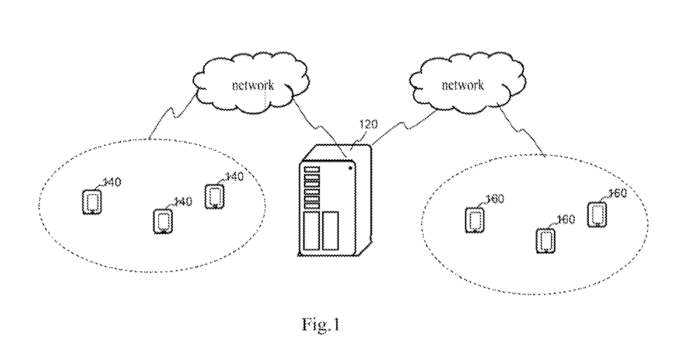

FIG. 1 is a structure schematic diagram showing an implementing environment related to the embodiments. As shown in FIG. 1, the implementing environment includes a server 120, first terminal(s) 140 and second terminal(s) 160.

The server 120 is configured to monitor service requests submitted by the terminals and may be one or more high-performance computers or cloud computing centers providing the service.

The first terminal 140 is a terminal such as mobile phone, tablet PC, ebook reader, desktop computer and laptop computer. The first terminal 140 may be connected with the server 120 via wire network or wireless network so that the server 120 may process the request sent from the first terminal.

The second terminal 160 is a terminal such as mobile phone, tablet PC, ebook reader, desktop computer and laptop computer. The second terminal 160 may be connected with the server 120 via wire network or wireless network to receive the instructions sent from the server 120.

### First Embodiment

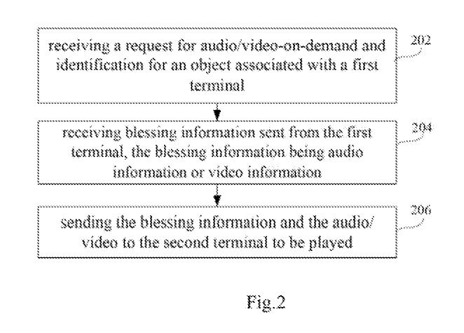

FIG. 2 is a flow diagram showing an audio/video-on-demand method according to the first embodiment of the disclosure. The audio/video-on-demand method may be applied to the server shown in FIG. 1. As shown in FIG. 2, the audio/video-on-demand method includes the following steps.

At S202, a request for audio/video-on-demand and identification for an object associated with a first terminal is received.

The first terminal 140 may be a mobile phone and the second terminal 160 may be a tablet PC, for example. When a user wants an audio/video-on-demand to be played for others, a request for audio/video-on-demand and identification for the object is input to the mobile phone through related operations performed by the user. Accordingly, the request for audio/video-on-demand and the identification for the object sent by the mobile phone will be received by the server. The object is associated with the tablet PC.

At S204, blessing information sent from the first terminal is received. The blessing information is audio information or video information.

The server receives the blessing information sent by the mobile phone via the wire or wireless network, wherein, the blessing information is audio information or video information. For example, the blessing information input to the mobile phone is a video named “AAAA”, and the server will receive the video named “AAAA” sent by the mobile phone as the blessing information.

At S206, the blessing information and the audio/video is sent to the second terminal to be played.

The server sends the received blessing information and the audio/video to the tablet PC to play them. For example, the server receives the blessing information such as the video named “AAAA” and the audio/video on-demand named “Happy Birthday” sent from the mobile phone and sends them to the tablet PC. After receiving the contents sent from the server, the tablet PC plays the video named “AAAA” and the audio named “Happy Birthday”.

This embodiment provides an audio/video-on-demand method. With this embodiment, the problems that it is inconvenient for the user to input literal information to the first terminal character by character and the literal blessing information may lead to inaccurate expression of the user's real emotion can be solved and the advantage of entering the blessing information conveniently and accurate expression of the user's real emotion can be achieved since the user can enter audio/video information as the blessing information.

### Second Embodiment

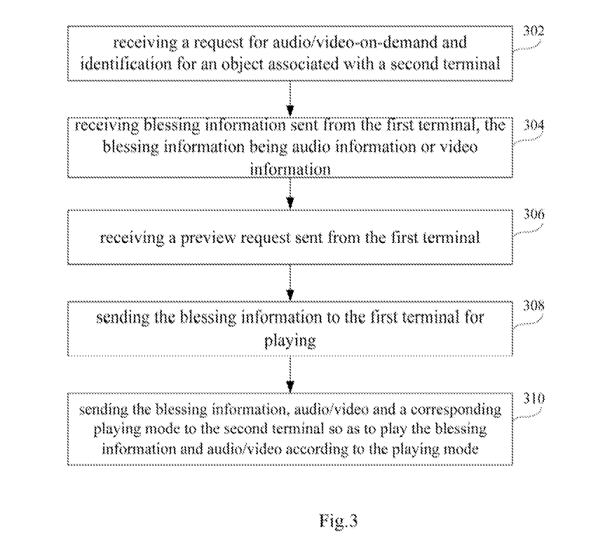

FIG. 3 is a flow diagram showing an audio/video-on-demand method according to the second embodiment of the disclosure. The audio/video-on-demand method may be applied to the server shown in FIG. 1. As shown in FIG. 3, the audio/video-on-demand method includes the following steps.

At S302, a request for audio/video-on-demand and identification for an object associated with a second terminal is received.

The first terminal 140 may be a mobile phone and the second terminal 160 may be a tablet PC, for example. The server may receive the request for audio/video-on-demand and identification for an object sent by the mobile phone. The object is associated with the tablet PC. For instance, when user “XIAO MA” wants to request a song named “Happy Birthday” for his friend “XIAO LI”, “XIAO MA” sends an request for a song named “Happy Birthday” and identification for the object (i.e., “XIAO LI” using the tablet PC) via his mobile phone, and then the server will receive the request for “Happy Birthday” and the identification for the object from the mobile phone.

At S304, blessing information sent from the first terminal is received. The blessing information is audio information or video information.

For better expression of user's emotion, the user may input blessing information for the on-demand audio/video, that is, the server will receive blessing information sent from the mobile phone, wherein, the blessing information is audio information or video information. For instance, after “XIAO MA” requests a song named “Happy Birthday” for his friend “XIAO LI”, the server may receive blessing information such as audio information “XXXXX” or video information recorded by “XIAO MA”.

At S306, a preview request sent from the first terminal is received.

Before the server sends the blessing information and audio/video to the tablet PC for playing, the user may select the preview option to check the blessing information. In other words, the server will receive a request for previewing the blessing information sent by the user via the mobile phone.

At S308, the blessing information is sent to the first terminal for playing.

After receiving the preview request for the blessing information sent from the mobile phone, the server sends the blessing information to the mobile phone for playing. For instance, the blessing information input by “XIAO MA” is audio information “XXXXX”; after receiving the preview request for the blessing information sent from the mobile phone, the server sends the audio information “XXXXX” to the mobile phone for playing.

At S310, the blessing information, audio/video and a corresponding playing mode is sent to the second terminal so as to play the blessing information and audio/video according to the playing mode.

After the mobile phone plays the blessing information, the user may send an acknowledging to the server via the mobile phone. After receiving the acknowledging, the server sends the blessing information, audio/video and a corresponding playing mode to the tablet PC so as to play the blessing information and audio/video according to the playing mode.

The playing mode may be any one of the following modes.

(1) The blessing information is played first, and then the audio/video is played.

When playing the blessing information and the audio/video, the tablet PC may play the blessing information first, and then play the audio/video. For example, when receiving the blessing information being audio information “XXXXX” and audio/video being a song named “Happy Birthday” sent from the server, the tablet PC used by “XIAO LI” will play the audio information “XXXXX” first, and then play the song named “Happy Birthday”.

(2) The blessing information is played first and ends with a fade-out mode, and then the audio/video starts with a fade-in mode.

For example, after receiving the audio information “XXXXX” sent from the mobile phone, the server sets the fade-out mode for the blessing information, such as “10 seconds” fade-out (e.g., reducing the volume gradually) at the end; after receiving the request for the song named “Happy Birthday” sent from the mobile phone, the server sets the fade-in mode for the song, such as “5 seconds” fade-in (e.g., increasing the volume gradually) at the start. Then the tablet PC will play the audio information “XXXXX” first and end it with a “10 seconds” fade-out mode, and then start the song named “Happy Birthday” with a “5 seconds” fade-in mode, so that the blessing information may be correlated with the audio/video better. In one example, fade-in and fade-out modes relates to increase or decrease of the volume gradually and/or the fading of the view.

This embodiment provides an audio/video-on-demand method. With this method, the problems that it is inconvenient for the user to input literal information to the first terminal character by character and the literal blessing information may lead to inaccurate expression of the user's real emotion can be solved and the advantage of entering the blessing information conveniently and accurate expression of the user's real emotion can be achieved since the user can enter audio/video information as the blessing information. Meanwhile, this embodiment can achieve a function that the user may preview the blessing information sent to the server through the technical solution that the blessing information is previewed on the first terminal before it is sent to the second terminal by the server.

### Third Embodiment

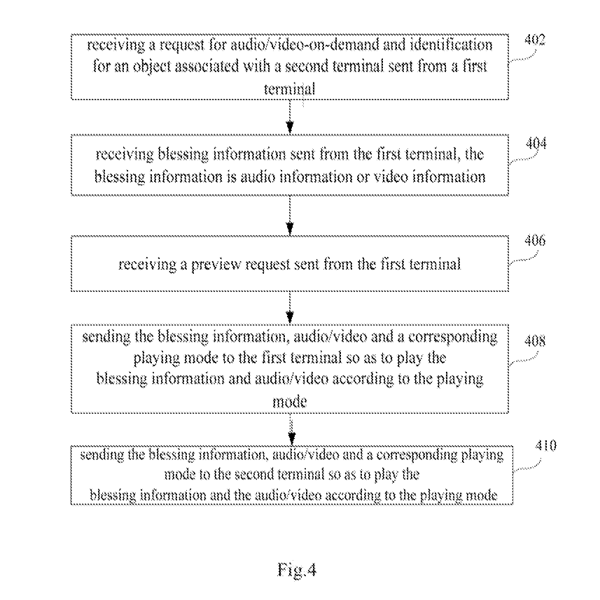

FIG. 4 is a flow diagram showing an audio/video-on-demand method according to the third embodiment of the disclosure. The audio/video-on-demand method may be applied to the server shown in FIG. 1. As shown in FIG. 4, the audio/video-on-demand method includes the following steps.

At S402, a request for audio/video-on-demand and identification for an object associated with a second terminal sent from a first terminal is received. The first terminal 140 may be a mobile phone and the second terminal 160 may be a tablet PC, for example. The server may receive the request for audio/video-on-demand and identification for the object sent by the mobile phone. The object is associated with the tablet PC.

At S404, blessing information sent from the first terminal is received, and the blessing information is audio information or video information.

For better expression of user's emotion, the user may input on-demand blessing information for the audio/video, that is, the server will receive on-demand blessing information sent from the mobile phone, wherein, the on-demand blessing information is audio information or video information.

S406, a preview request sent from the first terminal is received.

Before the server sends the on-demand blessing information and audio/video to the tablet PC for playing, the user may select the preview option to check the on-demand blessing information. In other words, the server will receive a request for previewing the on-demand blessing information sent by the user via the mobile phone.

At S408, the blessing information, audio/video and a corresponding playing mode is sent to the first terminal so as to play the blessing information and audio/video according to the playing mode.

After receiving the preview request for the on-demand blessing information and the audio/video sent from the mobile phone, the server sends the on-demand blessing information, the audio/video and the corresponding playing mode to the mobile phone so as to play the on-demand blessing information and audio/video according to the playing mode. Wherein, the playing mode specifies playing the blessing information first and then playing the audio or video, or starting the audio/video with a fade-in mode after ending the blessing information with a fade-out mode. The specific playing mode of the mobile phone is the same as that of the tablet PC described in S310 of the second embodiment (and not explained here).

At S410, the blessing information, audio/video and the corresponding playing mode is sent to the second terminal so as to play the blessing information and the audio/video according to the playing mode.

After the mobile phone plays the on-demand blessing information and the audio/video, the user may send an acknowledging to the server via the mobile phone. After receiving the acknowledging, the server sends the on-demand blessing information, the audio/video and the corresponding playing mode to the tablet PC so as to play the on-demand blessing information and the audio/video according to the playing mode. Wherein, the playing mode specifies playing the blessing information first and then playing the audio or video, or starting the audio/video with a fade-in mode after ending the blessing information with a fade-out mode. The specific playing mode of the tablet PC is the same as that of the tablet PC described in S310 of the second embodiment (and not explained here).

This embodiment provides an audio/video-on-demand method. With this method, the problems that it is inconvenient for the user to input literal information to the first terminal character by character and the literal on-demand blessing information may lead to inaccurate expression of the user's real emotion can be solved and the advantage of entering the on-demand blessing information conveniently and accurate expression of the user's real emotion can be achieved since the user can enter an audio/video information as the on-demand blessing information. Meanwhile, a function that the user may preview the on-demand blessing information, the audio/video and the corresponding playing mode can be achieved through the technical solution that the corresponding playing mode of the on-demand blessing information the audio/video is previewed on the first terminal before the on-demand blessing information and the audio/video are sent to the second terminal by the server.

### Fourth Embodiment

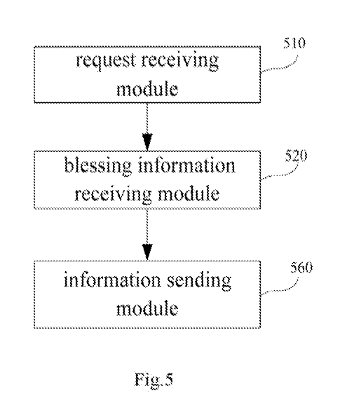

FIG. 5 is a structure block diagram showing an audio/video-on-demand server according to the fourth embodiment. As shown in FIG. 5, the audio/video-on-demand server comprises request receiving module 510, blessing information receiving module 520 and information sending module 560.

The request receiving module 510 is configured to receive a request for audio/video-on-demand and identification for an object associated with a second terminal sent from a first terminal.

The blessing information receiving module 520 is configured to receive blessing information sent from the first terminal, and the blessing information is audio information or video information.

The information sending module 560 is configured to send the blessing information and the audio/video to the second terminal to play them. Alternatively, after receiving an acknowledging sent from the first terminal, information sending module 560 sends the blessing information and the audio/video to the second terminal to play them.

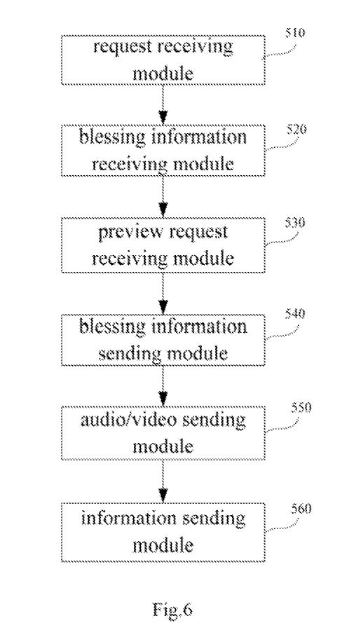

Preferably, as shown in FIG. 6, the audio/video-on-demand server further comprises preview request receiving module 530, blessing information sending module 540 and audio/video sending module 550. Wherein, preview request receiving module 530 is configured to receive a preview request sent from the first terminal; blessing information sending module 540 is configured to send the blessing information to the first terminal for displaying; and audio/video sending module 550 is configured to send the blessing information and the audio/video to the first terminal for displaying.

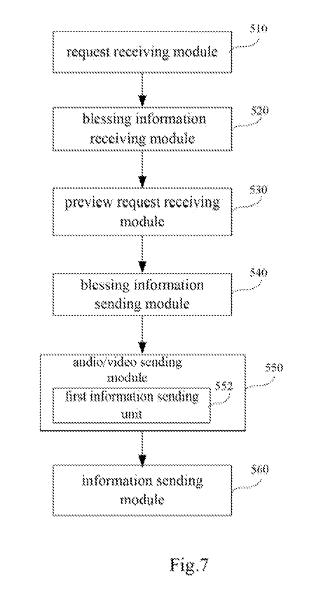

In particular, as shown in FIG. 7, audio/video sending module 550 comprises first information sending unit 552. First information sending unit 552 is configured to send the blessing information, audio/video and a corresponding playing mode to the first terminal so as to play the blessing information and audio/video according to the playing mode. The playing mode specifies playing the blessing information first and then playing the audio or video, or starting the audio/video with a fade-in mode after ending the blessing information with a fade-out mode.

In particular, as shown in FIG. 8, information sending module 560 comprises second information sending unit 562. Second information sending unit 562 is configured to send the blessing information, audio/video and the corresponding playing mode to the second terminal so as to play the blessing information and the audio/video according to the playing mode. The playing mode specifies playing the blessing information first and then playing the audio or video, or starting the audio/video with a fade-in mode after ending the blessing information with a fade-out mode.

This embodiment provides an audio/video-on-demand server. With the server, the problems that it is inconvenient for the user to input literal information to the first terminal character by character and the literal on-demand blessing information may lead to inaccurate expression of the user's real emotion can be solved and the advantage of entering the on-demand blessing information conveniently and accurate expression of the user's real emotion can be achieved since the user can enter an audio/video information as the on-demand blessing information.

### Fifth Embodiment

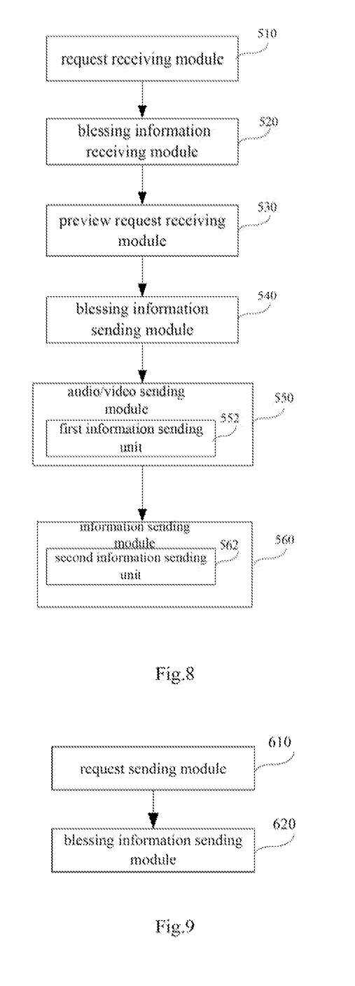

FIG. 9 is a structure block diagram showing a terminal, such as mobile phone, tablet PC, ebook reader, desktop computer and laptop computer, according to the fifth embodiment of the disclosure. As shown in FIG. 9, the terminal may comprises request sending module 610 and blessing information sending module 620. The request sending module 610 is configured to send a request for audio/video-on-demand and identification for an object associated with a second terminal to the server.

The blessing information sending module 620 is configured to send blessing information to the server, wherein, the blessing information is audio information or video information.

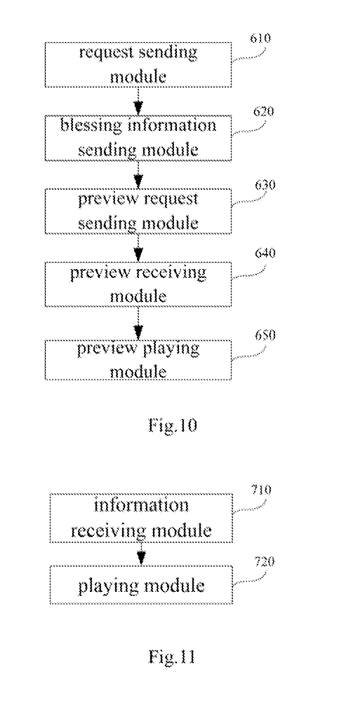

Preferably, as shown in FIG. 10, the terminal further comprises preview request sending module 630, preview receiving module 640 and preview playing module 650. Wherein, preview request sending module 630 is configured to send a preview request to the server; preview receiving module 640 is configured to receive blessing information, audio/video and a corresponding playing mode sent from the server, wherein, the playing mode specifies playing the blessing information first and then playing the audio or video, or starting the audio/video with a fade-in mode after ending the blessing information with a fade-out mode; and preview playing module 650 is configured to play the blessing information and audio/video according to the playing mode.

Alternatively, the terminal may further comprise input module for inputting audio information or video information as the blessing information by a user. Furthermore, request sending module 610 is configured to send an acknowledging to the server after preview playing module 650 plays the blessing information and/or audio/video.

This embodiment provides a terminal. With the terminal, the problem that it is inconvenient for the user to input literal information to the first terminal character by character can be solved and the advantage of entering the on-demand blessing information conveniently and accurate expression of the user's real emotion can be achieved since the user can enter an audio/video information as the on-demand blessing information.

### Sixth Embodiment

FIG. 11 is a structure block diagram showing a terminal, such as mobile phone, tablet PC, ebook reader, desktop computer and laptop computer, according to the sixth embodiment of the disclosure. As shown in FIG. 11, the terminal may comprises information receiving module 710 and playing module 720.

The information receiving module 710 is configured to receive blessing information, audio/video and a corresponding playing mode sent from the server, wherein, the playing mode specifies playing the blessing information first and then playing the audio or video, or starting the audio/video with a fade-in mode after ending the blessing information with a fade-out mode.

The playing module 720 is configured to play the blessing information and audio/video according to the playing mode.

This embodiment provides a terminal. With this terminal, the problem that the literal on-demand blessing information may lead to inaccurate expression of the user's real emotion can be solved and the accurate expression of the user's real emotion can be achieved through the technical solution that receiving blessing information, audio/video and a corresponding playing mode sent from the server and playing the blessing information and audio/video according to the playing mode, wherein, the blessing information is audio information or video information.

### Seventh Embodiment

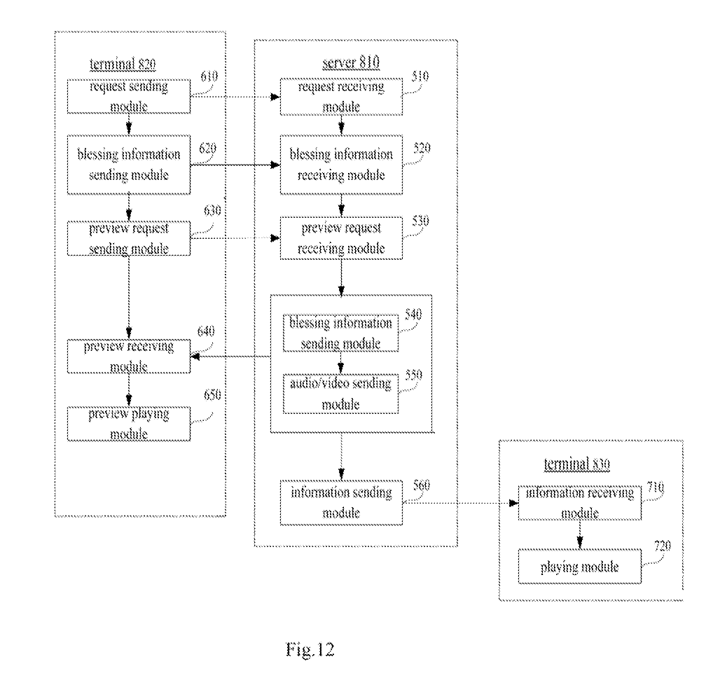

FIG. 12 is a structure block diagram showing an audio/video-on-demand system according to the seventh embodiment of the disclosure. As shown in FIG. 12, the audio/video-on-demand system comprises server 800, terminal 820 and terminal 830. Wherein, the detailed descriptions of server 800, terminal 820 and terminal 830 can be referred to the fourth, fifth and sixth embodiments (and not explained here), respectively.

This embodiment provides an audio/video-on-demand system. with this system, the problems that it is inconvenient for the user to input literal information to the first terminal character by character and the literal on-demand blessing information may lead to inaccurate expression of the user's real emotion can be solved and the advantage of entering the on-demand blessing information conveniently and accurate expression of the user's real emotion can be achieved since the user can enter an audio/video information as the on-demand blessing information.

It is noted that the audio/video-on-demand server provided in the above embodiment is merely illustrated with the above divided function modules when the audio/video is requested. In practice, the above functions may be performed by different function modules as needed. That is, the internal structure of an apparatus may be divided into a plurality of function modules to finish parts or all of the above described functions. In addition, the audio/video-on-demand server and audio/video-on-demand method provided in the above embodiments belong to the same conception and the detailed implementation process thereof may be referred to the above embodiments (and not explained here).

The sequence numbers of the embodiments are merely for description and do not represent the embodiments are better or not.

It is understood for those skilled in the art that parts or all of the steps of the above embodiments may be accomplished by hardware or by the related hardware instructed through program stored in a computer-readable storage medium, such as Read-only memory (ROM), disk and optical disk.

The above described embodiments are merely preferred embodiments of the disclosure, but not intended to limit the invention. Any modifications, equivalent alternations and improvements that are made within the spirit and scope of the invention should be included in the protection scope of the invention.

What is claimed is:

1. A method for providing audio or video on demand, comprising:
receiving, from a first terminal, a request for the audio or video and an identification for an object associated with a second terminal;
receiving blessing information from the first terminal, wherein the blessing information is audio information or video information; and
sending the blessing information and the audio or video to the second terminal for playing.

2. The method according to claim 1, further comprising:
receiving a preview request from the first terminal; and
sending the blessing information to the first terminal for playing or sending the blessing information and the audio or video to the first terminal for playing,
after the step of receiving blessing information from the first terminal and before the step of sending the blessing information and the audio or video to the second terminal for playing.

3. The method according to claim 2, wherein, the step of sending the blessing information and the audio or video to the first terminal for playing comprises:
sending the blessing information, the audio or video, and a corresponding playing mode to the first terminal so that the first terminal plays the blessing information and the audio or video according to the playing mode,
wherein, the playing mode specifies playing the blessing information first and then playing the audio or video, or starting the audio or video with a fade-in mode after ending the blessing information with a fade-out mode.

4. The method according to claim 1, wherein, the step of sending the blessing information and the audio or video to the second terminal for playing comprises:
sending the blessing information, the audio or video and a corresponding playing mode to the second terminal so that the second terminal plays the blessing information and the audio or video according to the playing mode,
wherein, the playing mode specifies playing the blessing information first and then playing the audio or video, or starting the audio or video with a fade-in mode after ending the blessing information with a fade-out mode.

5. The method according to claim 1, wherein,
receiving an acknowledgment from the first terminal before sending the blessing information and the audio or video to the second terminal for playing.

6. An audio and video on demand server, comprising:
a request receiving module, configured to receive, from a first terminal, a request for the audio or video and an identification for an object associated with a second terminal;
a blessing information receiving module, configured to receive blessing information from the first terminal, wherein the blessing information is audio information or video information; and
an information sending module, configured to send the blessing information and the audio or video to the second terminal for playing.

7. The server according to claim 6, further comprising:
a preview request receiving module, configured to receive a preview request from the first terminal;
a blessing information sending module, configured to send the blessing information to the first terminal for playing; and
an audio and video sending module, configured to send the blessing information and the audio or video to the first terminal for playing.

8. The server according to claim 7, wherein, the audio and video sending module comprises:
a first information sending unit, configured to send the blessing information, the audio or video, and a corresponding playing mode to the first terminal so that the first terminal plays the blessing information and the audio or video according to the playing mode,
wherein, the playing mode specifies playing the blessing information first and then playing the audio or video, or starting the audio or video with a fade-in mode after ending the blessing information with a fade-out mode.

9. The server according to claim 6, wherein, the information sending module comprises:
a second information sending unit, configured to send the blessing information, the audio or video and a corresponding playing mode to the second terminal so that the second terminal plays the blessing information and the audio or video according to the playing mode,
wherein, the playing mode specifies playing the blessing information first and then playing the audio or video, or starting the audio or video with a fade-in mode after ending the blessing information with a fade-out mode.

10. The server according to claim 6, wherein,
the information sending module is configured to send the blessing information and the audio or video to the second terminal for playing after receiving an acknowledgment from the first terminal.

11. The server according to claim 6, wherein,
the server is a high-performance computer or a cloud computing center.

12. A terminal, comprising:
a request sending module, configured to send a request for audio or video on demand and an identification for an object associated with a second terminal to a server; and
a blessing information sending module, configured to send blessing information to the server, wherein the blessing information is audio information or video information.

13. The terminal according to claim 12, further comprising:
a preview request sending module, configured to send a preview request to the server;
a preview receiving module, configured to receive the blessing information, the audio or video and a corresponding playing mode from the server, wherein, the playing mode specifies playing the blessing information first and then playing the audio or video, or starting the audio or video with a fade-in mode after ending the blessing information with a fade-out mode; and
a preview playing module, configured to play the blessing information and the audio or video according to the playing mode.

14. The terminal according to claim 12, further comprising:
an input module, configured to receive input of audio information or video information as the blessing information from a user.

15. The terminal according to claim 13, wherein,
the request sending module is further configured to send an acknowledging to the server after the preview playing module plays the blessing information and the audio or video.

16. The terminal according to claim 12, wherein,
the terminal is a mobile phone, a tablet PC, an ebook reader, a desktop computer or a laptop computer.
